(19) United States
(12) Patent Application Publication
(10) Pub. No.: US 2025/0013217 A1
(43) Pub. Date: Jan. 9, 2025

(54) Method and Arrangement for Securely Accessing an Industrial Automation Component

(71) Applicant: Siemens Aktiengesellschaft, Muenchen (DE)

(72) Inventors: Diego Gerardo LOPEZ PADILLA, Nürnberg (DE); Matthias SCHEURER, Haßloch (DE)

(21) Appl. No.: 18/761,375

(22) Filed: Jul. 2, 2024

(30) Foreign Application Priority Data
Jul. 4, 2023 (EP) 23183180

(51) Int. Cl. G05B 19/042

(52) U.S. Cl. CPC G05B 19/0428; G05B 2219/24162

(57) ABSTRACT

A method and arrangement for securely accessing an industrial automation component via a mobile device, wherein the automation component is blocked against unauthorized access, valid access information is stored on the mobile device and, when in the vicinity of the automation component, transmitted to a radio unit and checked in the automation component, such that the automation component is then enabled for access.

### BACKGROUND OF THE INVENTION

### 1. Field of the Invention

The invention relates to an arrangement and method for securely accessing an industrial automation component.

### 2. Description of the Related Art

Within industrial automation systems, a large number of computer-controlled automation components, such as control and monitoring devices (HMI-Human Machine Interface), programmable logic controllers (PLCs), computers and/or machines, are normally installed, which have a graphical user interface and which are operated by employed personnel (OP-operator).

Particularly in larger or difficult to protect manufacturing environments, the production machines or other automation components are normally protected against unauthorized access, so that a person (hereafter also referred to as an operator) must first be authenticated before they can access critical information or initiate critical operations.

Traditionally, authentication is performed in most cases by entering a user name and password (for example, on the standard HDMI panels) or by using personalized ID cards and associated wireless readers, which usually operate wirelessly over short distances using RFID technology. An example of this is the Simatic RF 1000 system from the manufacturer Siemens.

Each of the usual measures for access control are known to have specific disadvantages. In the case of common passwords, users tend to use passwords that are too simple or easy to guess; in the case of PIN entries, access can be forced through brute force attacks; access information (so-called credentials) can be forgotten; and in cases where a display does not have a touch interface, additional way to input information such as a keyboard or computer mouse are required.

In the case of the aforementioned electronic ID cards, these cards can be stolen and misused by unauthorized personnel, the cards can also be forgotten, or the certificate stored on these access cards can expire and thus become invalid. In addition, the described conventional methods for authentication and authorization have the disadvantage that the corresponding persons, for example, in the event of a service or in an emergency, must first be created/registered as users in the system, and then access information (cards, user names and/or passwords) must be generated and issued to the persons.

These described disadvantages cause disruption particularly in the event of a machine malfunction or other extraordinary event, if an operating state has arisen on the automation component for which specialized external maintenance personnel need to be called in temporarily and must be approved for the corresponding automation component. In the prior art, no optimized set-up for industrial “guest accesses” is known and, moreover, the described prior-art methods do not allow multi-factor authentication, as is known, for example, from online banking and other applications.

Another disadvantage of conventional automation components and their graphical user interfaces is that, although they may be dimensioned sufficiently for daily operation, in the event of an alarm or maintenance, however, the necessary increased ergonomics cannot be achieved, in particular it may constitute too little situation-specific information and often also have insufficient way to input and output information (for example, only a touch display, but no keyboard or the like), which are helpful or even necessary in special situations.

### SUMMARY OF THE INVENTION

In view of the foregoing, it is therefore an object of the present invention to simplify the authentication—in particular of external operating personnel—in industrial automation components and to improve access to industrial automation components, particularly in the event of emergencies and similar operating states.

A core way to achieve the object in accordance with the invention, in particular in the event of particular operating conditions (for example in the event of a fault), is to generate specific, electronic access information for an operator required for a specific situation and, together with specific information about the current situation, for example, to send information about an existing fault and instructions or resources for correcting this fault, to a mobile device of the designated operator and store it there. When this operator arrives at the automation component concerned, this person can then log on to the automation component using the access information. This is similar to using an RFID-based access card or to the payment process with a contactless payment method at the supermarket checkout. It is then possible for the operator to access the previously transmitted specific information with the mobile device and to also use the mobile device as an operating or input device for the automation component, such as by entering and transmitting commands, and/or downloading diagnostic software or new operating software. The last-mentioned steps do not necessarily have to be performed via an RFID radio module of the automation component, but can be transmitted via an Internet connection of the mobile device to the factory and thus to the automation component, for which purpose the corresponding address information and the like have advantageously been transmitted to the mobile device already with the specific information.

The foregoing objects and advantages are therefore achieved in accordance with the invention by an arrangement and a method for securely accessing an industrial automation component via a mobile device, where the automation component is blocked for unauthorized access, and where the automation component is equipped with a radio unit for receiving wirelessly transmitted access information, and where valid access information is stored on the mobile device and, when in the vicinity of the automation component, transmitted to the radio unit and checked in the automation component and thereafter, in the positive case, the automation component is enabled for access. In a first step, at least one operator responsible for a current operating state is selected. In a second step, the automation component or an associated server component selects or creates personalized access information for the selected operator. In a third step, specific information about the operating state and the valid access information is transmitted to the operator's mobile device. In a fourth step, moreover, the operator gains access to the automation component via the access information and performs inputs or other operator actions on the automation component via the specific information via the mobile device. With the inventive method, in particular for servicing purposes, an operator can obtain situation-specific access to the affected automation component, have the necessary information provided to them and authenticate themselves on and operate the automation component by means of the operator's personal mobile device.

The objects and advantages are also achieved in accordance with the invention by an arrangement for securely accessing an industrial automation component via a mobile device. The automation component is equipped with a radio module for exchanging access information with a mobile device, where the automation component or a server component linked to the mobile device is configured to generate the access information for a selected operator in a manner related to a current operating state of the automation component, and to create specific information about the operating state and to transmit the access information and the specific information to the mobile device, where the mobile device is configured to authenticate the operator on the automation component by transmitting the access information to the radio module, and where the mobile device is configured to display and/or use the specific information to operate or influence the automation component. This device makes it possible to achieve the above-described advantages of the inventive method.

The inventive method can be applied in a particularly advantageous way if the operating state is a malfunction, error, alarm state or other event, and if the method steps are initiated when such an event occurs. In such a case, for example, an external consultant or specialist can be called upon as an operator, where the required information can then advantageously be sent to this operator at the time of issuing the contract, along with the required access authorization in the form of the electronic access information, direct to the personal mobile device of the operator, such as a smartphone or tablet computer. The access information may also be time-limited for those persons who do not normally have access to the production site or the specific automation component. This time limit can either be stored digitally in the access information, such as in a digital certificate, but it can also be stored in the factory infrastructure, in particular in the automation component concerned, so that no access is granted outside a temporally specified window. Advantageously, the access information is personalized such that it can only be activated together with the personal mobile device of the operator or together with their biometric inputs (for example, fingerprint, facial recognition). In a further embodiment, the operating person can also be issued an additional piece of secret information for a multi-factor authentication, such as an activation PIN, via a different route, where this additional secret information must then be entered either on the mobile device to activate the access information or on the relevant automation component. Advantageously, the access information or a piece of additional access information sent virtually in parallel can temporarily allow entry to a building or site and thus allow access to the automation component via automatic access control systems.

It is advantageously also advantageous to specify the respective access authorization (for specific purposes and times) of the respective operator, in particular to the user interface of the automation component, on the basis of identity or of stored qualifications or of assigned personalized restrictions, and to link this specified access authorization to the respective access information, thus restricting or enabling subsequent access operations by the respective operator accordingly. This makes it possible to restrict the access of the selected person to information and functions of the automation component that correspond to a general authorization of this person and that are necessary to solve the current problem. On a case-by-case basis, these restrictions or approvals may also be variable for a given person, depending on the event justifying the current generation of the access authorization.

The method is advantageously applied when an industrial operating and monitoring device or a control device for an industrial process or a production automation system is used as the automation component. Such automation components already normally have the required computing power and can easily be equipped with a radio module or reader for the wireless access information. Furthermore, such automation components are normally connected to a data network, which means that operator actions that are performed on the mobile device do not necessarily have to be implemented via the radio connection or other direct radio coupling used for the registration on the device, for example, using the Bluetooth protocol, rather the further data exchange between the mobile device and the automation component concerned can occur via the data network described. For example, a web server can be launched on the automation component or a server connected to it, and a web browser can be launched on the mobile device, so that after the corresponding access information and URLs have been configured, a user interface of the automation component can be displayed on the mobile device. This also makes it possible to upload files, in particular software installations, from the mobile device to the automation component and install them there. It should be understood such a transfer of software can also occurs in other ways.

In an alternative embodiment, the specific information can also contain or refer to a specific application, i.e., an application (app), which is launched on the mobile device and which serves as a user interface for operating or “repairing” the automation component. The resulting data traffic between the automation component and the mobile device can be performed as described via the Internet and the factory intranet, but can also be performed directly, such as via a Bluetooth connection or an ad-hoc WLAN connection between the automation component and the mobile device.

As described, the radio unit is configured for exchanging information using an RFID protocol, in particular for bi-directional data exchange. Alternatives are possible, in particular the use of the Bluetooth protocol or other short-range radio connection. The use of such short-range radio connections is particularly advantageous because it can ensure that the operator is in the immediate vicinity of the automation component when accessing it and is not accessing it inadvertently or even improperly from a distance. In particular, it is possible to have a QR code displayed on the display of the mobile device as access information, which is read by a camera of the automation component and, given an appropriate match, access is then granted. In a further advantageous embodiment, the automation component is also provided with a QR code, which is scanned by the camera of the mobile device and then compared with the access information, either within the mobile device or by a server connected to the mobile device, after which access to the automation component is enabled via the data connection of the mobile device, a corresponding gateway to the automation network and thus via the factory data network.

The specific information and the access information are advantageously transmitted in bundled form to the mobile device, in particular to an industrial application of the mobile device. In the simplest case, this information is transmitted in an SMS message, an e-mail, or a social network message. Bundling ensures that one of the two information units is not separated from the other by mistake or due to a technical error and that it is not transmitted or otherwise. It is particularly advantageous to operate a small application, i.e., a special app, on the mobile device, which receives the bundled information, stores the access information in a special storage area or information store (“wallet”) of the mobile device, and makes the other information accessible to the user via a special graphical user interface. In particular, such an application or app can also be a specially configured graphical user interface for the industrial automation component, where based on the specific information the appropriate or correct user interface can also be selected and configured from a series of available user interfaces.

As previously mentioned, the special storage area or information store (“wallet”) is protected with biometric information or characteristics of the respective operator, where the operator identifies him/herself on the mobile device via this biometric information or these characteristics before transmission of the access information to the automation component. The further information or the user interface represented by the described app or a browser of the mobile device can additionally be protected by such biometric information, personal characteristics, password or PIN.

Many possible persons are advantageously stored in the overall system for many wrongly different use cases, where a number of suitable operators are selected from this number of available operators based on the current operating state and the specific information and the respective access information are transferred to the mobile devices of these selected operators. It also possible for one of the notified persons to accept the order associated with the notification, in particular via a confirmation on their mobile device, and for the other notified persons to receive a cancellation as a result. A hierarchical notification concept can also be implemented, so that the most suitable person is informed first, and in the event that this person does not positively acknowledge the notification, the next best suitable person is informed by sending the information to them, etc.

Advantageously, the operators are automatically suggested or selected based on stored previous manual selections of operators or based on skills assigned to the available operators in relation to comparable operating states. This ensures that no unsuitable operators are consulted.

The specific information sent is thus advantageously adapted to the current situation and hence to the current operating state of the automation component or the associated digital factory, where an instruction and/or digital resources and/or a software variant adapted for the current operating state or other files for the automation component are particular transmitted to the mobile device along with the specific information. After being approved by the operator, the adapted software version or a file or operating commands are sent from the mobile device to the automation component.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the method according to the invention and the device according to the invention is explained below with reference to the drawing, in which:

FIG. 1 shows a schematic representation of wireless access to an automation component via a mobile device in accordance with the invention;

FIG. 2 shows the generation and transmission of access information to a mobile device in accordance with the invention;

FIG. 3 is a flowchart of the method in accordance with the invention.

### DETAILED DESCRIPTION OF THE EXEMPLARY EMBODIMENTS

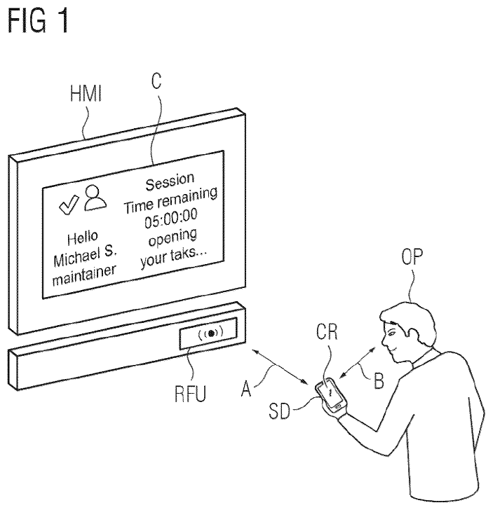

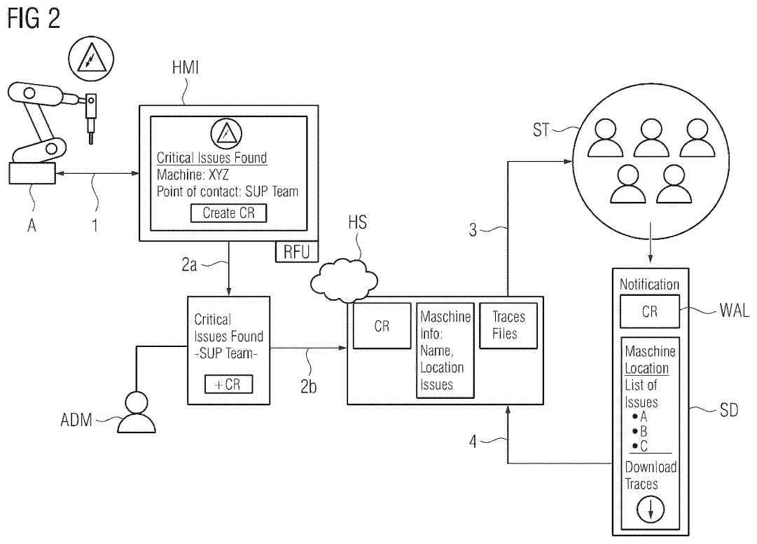

The reference signs introduced with FIG. 1 also apply to the explanations with respect to FIG. 2 and the reference signs introduced with FIG. 2 also apply to the explanations with respect to FIG. 1.

FIG. 1 schematically shows the local access by an operating person OP (operator) to an automation component human machine interface (HMI). Here, the automation component HMI, which represents a classical operator control and monitoring device, is used to control a machine or the like, such as a robot. Such a machine A is shown in FIG. 2 as an example. In other exemplary embodiments, the user interface shown on the automation component HMI can also be displayed directly by a correspondingly equipped machine A. Consequently, in the context of the present invention, the automation component HMI refers to the operable part of a machine A or its user interface.

Essentially, in the context of FIG. 1 it is assumed that valid access information credential CR is stored on a mobile device SD (smart device) of the operator OP, such as in the manner of a virtual credit card on a mobile phone used for contactless payment. When the mobile device SD approaches a radio module RFU (RFID Unit) of the automation component HMI, the two devices contact each other in step A, after which in a step B the operator OP enables the use of the access information CR, for example, by facial recognition, by entering a fingerprint, or by entering a PIN. In step C, a session is opened for this operator OP on the automation component HMI. The automation component HMI repeatedly checks whether the mobile device SD is still within radio range of the RFU radio module; otherwise, the session is closed. The operator OP can now operate the automation component HMI using the mobile device SD, for example, using an app or another graphical user interface (e.g., in a browser), where the necessary data transfer is not necessarily required to be handled via the radio module RFU. In addition, the operator OP can also access pre-stored background information and other digital resources, files, etc. on their mobile device SD, which have previously been tailored according to the specific situation and in relation to the specific automation component HMI or to the operating state of a connected machine A (shown in FIG. 2) and optionally also to the skills of the operator OP.

FIG. 2 shows, by way of example, how in accordance with the invention an employee of a support team ST is selected as an operator OP according to the situation and supplied with access information CR and specific information about a current operating state of the machine A.

Here, it should be understood that a critical operating state occurs on the machine A, for example, an error or a machine fault, where information about this current operating state is transmitted in step 1 from the machine A to the automation component HMI in the form of an error message/error code. This error is displayed on a user interface of the automation component HMI, where a machine operator or another person present can press a button marked “Create CR” to call upon a qualified operator OP. In an embodiment not described further here, this step can also be dispensed with; the automation component HMI or a maintenance server (not shown) or a host system HS can be set up such that a qualified operator OP is selected automatically and called upon without further manual intervention for certain errors. In such a case, the automation component HMI can perform the process of selecting this operator OP and the generation of tailor-made access information CR for the selected operator(s) OP, compile suitable specific information (Machine Info: name, location, issues; Trace Files, etc.) about the error or operating state, bundle these together with the access information CR and send them to the selected operator(s) OP.

In the embodiment discussed below, the error message is sent to the workstation of an administrator ADM (step 2a) after the operating state or error has been detected and after the “Create CR” button has been pressed, or alternatively without this confirmation step. A number of employees are suggested to the administrator ADM from a database of employees from his/her support team ST by his/her workstation computer or server or the host system HS, who are identified in the database as suitable for dealing with errors in the detected operating state or faults. Each of these employees is assigned specific authorization classes for access to the HMI automation component, such as administrator rights, standard user rights, restricted user rights or the like, in accordance with their respective qualifications and approval. For each of the selected users, access information is then generated or retrieved from an employee directory, where the corresponding access authorizations (administrator, standard user, restricted user, etc.) are either assigned to the respective access information or incorporated directly into it.

A list containing the assigned, valid access information and the respective restrictions or approvals is then transmitted to the automation component HMI; in the case in which the restrictions are part of the digital access information CR, however, the latter information does not need to be transmitted to the automation component HMI. The administrator ADM then generates specific information about the current operating state, which includes, for example, a description of the errors present (issues), extracts of an electronic operating manual of the corresponding machine A, a diagnostic software required for the present operating state or a reference (link) to such software, trace-files (files with diagnostic information), and the like. Advantageously, this additional specific information is provided partially or fully automatically by the computer or server of the administrator ADM, or, in another embodiment, by the automation component HMI. This can be implemented, for example, by specifying in a decision matrix not only which type of employee from the support team ST is eligible for handling which operating state or error, but also specifying which information must be provided about machine A, which access rights are required, how long access rights must be valid and the like, for which operating state or error.

The access information CR that has now been generated (step 2b) is sent to the host system HS together with the specific information (or details or links or URLs relating to it) and then bundled by the host system HS with the specific information and sent individually to the selected employees of the support team ST or their personal mobile devices SD in encrypted form (step 3). The selected members of the support team ST now have the opportunity to view and accept the order specified in terms of type, urgency and estimated processing time, on their mobile device. If necessary, the selected members of the support team ST can also be notified in a specified order, such as in the order of descending qualifications or ascending cost, distance away, etc. Once an employee accepts the order, a corresponding response message is sent to the host system HS, which cancels or pauses the order offer for the other employees. The access information CR transmitted with the data package is accepted into the secure information store WAL (wallet) of the mobile device SD of the employee who has positively acknowledged the service request. Depending on the type of information components, the specific information is either stored in the file system of the mobile device SD, displayed in a browser, or stored in a special service application (app). The employee now selected can now visit the factory with machine A or the automation component HMI and access the automation component HMI as an operator OP, as already explained based on the example of FIG. 1.

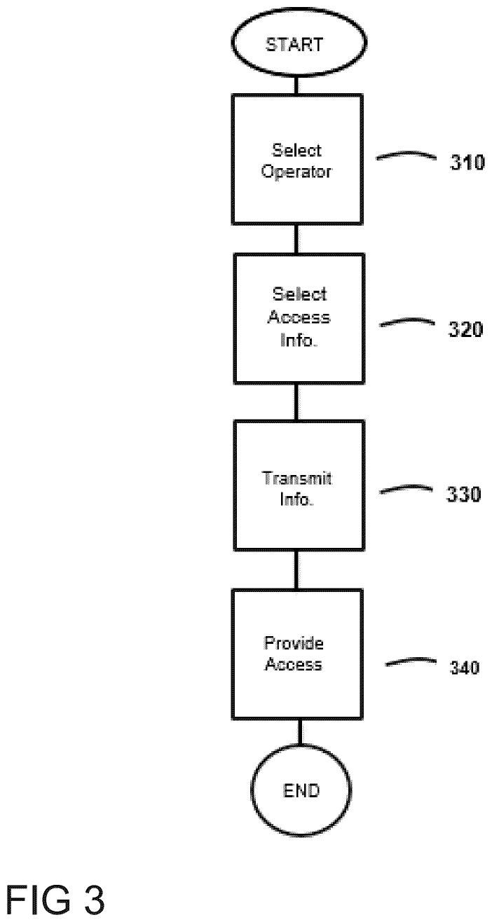

FIG. 3 is a flowchart of the method for securely accessing an industrial automation component HMI via a mobile device SD, where the automation component HMI is blocked against unauthorized access, the automation component HMI is equipped with a radio unit RFU for receiving wirelessly transferred access information CR, valid access information CR is stored on the mobile device SD and, when in a vicinity of the automation component HMI, transmitted to the radio unit RFU and checked in the automation component HMI, and in a positive case, the automation component HMI is then enabled for access.

The method comprises selecting at least one operator OP responsible for a current operating state, as indicated in step 310.

Next, either the automation component HMI and/or an associated server component HS selects or creates personalized access information CR for the selected at least one operator OP, as indicated in step 320.

Next, specific information about the current operating state and the valid access information CR are transmitted to the mobile device SD of the operator OP, as indicated in step 330.

Next, the operator OP is provided with access to the automation component HMI via the access information CR, as indicated in step 340. Here, the operator OP performs inputs or other operator actions on the automation component HMI via the specific information via the mobile device SD.

Using the above-described method, access to industrial plants, machines or components can also be given to external persons depending on the situation, taking advantage of the fact that today virtually everyone has a personal mobile device SD (e.g. mobile phone, tablet PC, laptop). This is an access key, HMI device, help system and data store in one. Common operating and communication patterns are used that are already familiar to every employee. The described infrastructure makes it possible to define the nature, duration and scope of the access authorization for each individual and, together with all necessary information and resources, to create it individually for the current situation or operating state and make it available to the selected employee or employees in advance. With the proposed method or proposed infrastructure, it is also possible to integrate comprehensive security measures such as 2-factor authentication, the use of biometric authentication, etc. into the concept. The concept allows both internal and external employees to gain permanent or temporary access (Full Access, Limited Access).

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for securely accessing an industrial automation component via a mobile device, the automation component being blocked against unauthorized access, the automation component being equipped with a radio unit for receiving wirelessly transferred access information, valid access information being stored on the mobile device and, when in a vicinity of the automation component, transmitted to the radio unit and checked in the automation component, and in a positive case, the automation component then being enabled for access, the method comprising:
selecting at least one operator responsible for a current operating state;
selecting or creating, by at least one of the automation component or an associated server component, personalized access information for the selected at least one operator;
transmitting specific information about the current operating state and the valid access information to the mobile device of the operator; and
providing the operator with access to the automation component via the access information, said operator performing inputs or other operator actions on the automation component via the specific information via the mobile device.

2. The method as claimed in claim 1, wherein the operating state comprises one of a malfunction, error, alarm state and other event; and wherein the method is initiated when such an event occurs.

3. The method as claimed in claim 1, wherein a respective access authorization of a respective operator is specified based on an identity, stored qualifications or assigned personalized restrictions, a specified access authorization being linked to a respective personalized access information such that subsequent access operations by the respective operator are accordingly restricted or enabled.

4. The method as claimed in claim 1, wherein the automation component comprises an industrial operating and monitoring device, a control device for an industrial process or a production automation system.

5. The method as claimed in claim 1, wherein the radio unit is configured to exchange information based on an RFID protocol.

6. The method as claimed in claim 5, wherein the radio unit is configured to exchange information based on a bi-directional data exchange.

7. The method as claimed in claim 1, wherein the specific information and access information are transmitted in bundled form to the mobile device.

8. The method as claimed in claim 7, wherein the specific information and access information are transmitted in bundled form to an industrial application of the mobile device.

9. The method as claimed in claim 1, wherein the access information is stored in a protected information store of the mobile device.

10. The method as claimed in claim 9, wherein the protected information store comprises an electronic wallet.

11. The method as claimed in claim 9, wherein the information store is protected with biometric information or characteristics of the respective operator; and
wherein the operator identifies him/herself on the mobile device via the biometric information or characteristics before transmission of the access information to the automation component.

12. The method as claimed in claim 1, wherein the specific information is utilized to create or configure a graphical user interface on the mobile device adapted to at least one of the automation component and the operating state to operate the automation component.

13. The method as claimed in claim 1, wherein a number of suitable operators are selected from a number of available operators based on the current operating state, and the specific information and the respective access information are sent to the mobile devices of these selected operators.

14. The method as claimed in claim 13, wherein the operators are automatically suggested or selected based on stored previous manual selections of operators or based on skills assigned to available operators in relation to comparable operating states.

15. The method as claimed in claim 1, wherein the specific information is utilized to send at least one of (i) an action instruction, (ii) digital resources and (iii) one of a software version adapted to the current operating state and other files for the automation component to the mobile device.

16. The method as claimed in claim 15, wherein one of (i) the adapted software version, (ii) a file and (iii) operating commands is sent from the mobile device to the automation component after being approved by the operator.

17. An arrangement for securely accessing an industrial automation component via a mobile device, wherein the automation component is equipped with a radio module for exchanging access information with a mobile device;
wherein the automation component or a server component linked to the mobile device is configured to generate the access information for a selected operator in a manner related to a current operating state of the automation component and to create specific information about the operating state and to transmit the access information and the specific information to the mobile device;
wherein the mobile device is configured to authenticate the operator on the automation component by transmitting the access information to the radio module; and
wherein the mobile device is configured to at least one of display and utilize the specific information to operate or influence the automation component.
